(19) United States
(12) Patent Application Publication
(10) Pub. No.: US 2004/0210575 A1
(43) Pub. Date: Oct. 21, 2004

(54) Systems and methods for eliminating duplicate documents

(76) Inventors: Douglas M. Bean, Centerville, UT (US); Brad S. Perry, North Salt Lake City, UT (US); Joseph Taj, Bountiful, UT (US); Robert T. Smith, Salt Lake City, UT (US)

Correspondence Address: KIRTON AND MCCONKIE, 1800 EAGLE GATE TOWER, 60 EAST SOUTH TEMPLE, P O BOX 45120, SALT LAKE CITY, UT, 84145-0120, US

(21) Appl. No.: 10/418,948

(22) Filed: Apr. 18, 2003

(51) Int. Cl. G06F 17/30

(52) U.S. Cl. 707/6

(57) ABSTRACT

Systems and methods for eliminating duplicate document information and document images prior to or after coding, rekeying, using optical character recognition, searching or producing the documents. Multiple documents are identified to determine whether or not they are duplicate documents. Corresponding sample areas or points of the documents are identified and the corresponding pixels of the sample areas or points are compared to determine whether or not the pixels are identical. If no match occurs, it is determined that the documents are not identical. However, if the pixels in the corresponding sample areas or points match, a more detailed sampling process and a more complex comparison technique is utilized to confirm whether or not the documents are in fact duplicate copies. Documents that are determined to be non-duplicates may undergo a coding process or other process as required by the user.

### BACKGROUND OF THE INVENTION

1. Field of the Invention

The present invention relates to eliminating duplicate document information and document images (collectively “documents”) prior to or after coding, rekeying, using optical character recognition, searching or producing the documents. In particular, the present invention relates to systems and methods for identifying sample areas of documents, comparing pixels of the sample areas, and performing a more detailed sampling and comparison process if the pixels of the original sample areas match.

2. Background and Related Art

With the emergence of the personal computer, individuals and companies have become more and more dependent on electronic data. With increased amounts of electronic data currently available, the ability to efficiently manage and process the data has proven to be particularly valuable.

Because electronic data resides on a variety of computers and other electronic devices such as on a PDA, zip disk, etc., and because this data is created in a variety of formats and programs, such as, email files, word processing files, spreadsheet files, and can also reside in a variety of different locations, such as intranets, computer hard drives, and back-up storage devices, a user cannot typically search and retrieve all relevant data from a single database location. In addition, some information does not reside in an electronic format at all, but is only maintained as a paper image or handwritten documents. As a result, on important matters users often need to gather all existing electronic data and also scan, code, OCR, or rekey all non-electronic data to convert it into an electronic format. This information is then loaded into an electronic database program which can be used to search, review and produce the data.

While this process is extremely useful in gathering and searching among all relevant data, by its nature the process may gather many duplicate documents. For example, a paper document may be reproduced and distributed to a number of different readers. This duplication process is also commonplace among electronic documents. For example, an email message is frequently sent to a number of recipients at one time. Because the gathering process does not identify duplicate documents, generally they all get placed in an electronic database file.

The existence of duplicate documents creates a number of problems. First, it is expensive to code, OCR or rekey (collectively, “code”) the same document multiple times after they are each scanned or received in an electronic format. Second, the utility of the databases is reduced because a search request could retrieve multiple copies of the same document. This can significantly slow down the review process by the users of the database, as they look for relevant documents. Finally, the preserving of duplicate copies of electronic data is a waste of network resource space and processing power.

Thus, while techniques currently exist that are used to capture and manage electronic data, challenges still exist. Current techniques for eliminating duplicates are based on subjective search criteria and comparisons. For example, after coding bibliographic information about each document entered into a database, searches can be conducted using the same data, author and recipient fields to determine whether duplicates exist. However, this process is inefficient because it does not eliminate the need to code the documents after they are scanned or received in an electronic format. Also, it takes a fair amount of time for individuals to make these individually crafted searches through large databases and manually determine whether certain documents are duplicates. As a result, it is often more costly to try and eliminate duplicates than it is to simply allow them to reside on an electronic database collection. Accordingly, it would be an improvement in the art to augment or even replace current techniques with other techniques.

### SUMMARY OF THE INVENTION

The present invention relates to eliminating duplicate document information and document images (collectively “documents”) prior to or after coding, rekeying, using optical character recognition, searching or producing the documents. In particular, the present invention relates to systems and methods for identifying sample areas of documents, comparing pixels of the sample areas, and performing a more detailed sampling and comparison process if the pixels of the original sample areas match.

Implementation of the present invention takes place in association with a computer device that is used to eliminate duplicate documents prior to or after coding the documents. Multiple documents are identified to determine whether or not they are duplicate documents. Corresponding sample areas or points of the documents are identified and the corresponding pixels of the sample areas or points are compared to determine whether or not the pixels are identical. If no match occurs, it is determined that the documents are not identical. However, if the pixels in the corresponding sample areas or points match, a more detailed sampling process and a more complex comparison technique is utilized to confirm whether or not the documents are in fact duplicate documents.

In at least some implementations, the systems and methods of the present invention are utilized for the purpose of identifying duplicate documents before they undergo a coding process. The elimination of duplicate copies prior to coding eliminates the use of unnecessary processing power and resources since duplicate copies of the same document are no longer being coded. The elimination of duplicate documents also reduces the time necessary to conduct searches in an electronic database because the user no longer needs to go through each duplicate identified. In some computer environments, the elimination of duplicate copies provides the advantage of allowing a search engine to work faster than with previous techniques since the search engine no longer needs to find and identify several versions of the same document. Also, hardware needed for storage of electronic data is reduced when duplicates are eliminated.

In some implementations, only one document is preserved. In other implementations, the duplicates are preserved in a separate location, such as in an extra file in a database. In a further implementation, information relating to the duplicate copies is tracked. For example, information relating to the users or computers that have accessed a duplicate copy is tracked.

While the methods and processes of the present invention have proven to be particularly useful in computer environments that include a database, those skilled in the art will appreciate that the methods and processes can be used in a variety of different system configurations and/or environments to selectively eliminate redundant documents.

These and other features and advantages of the present invention will be set forth or will become more fully apparent in the description that follows and in the appended claims. The features and advantages may be realized and obtained by means of the instruments and combinations particularly pointed out in the appended claims. Furthermore, the features and advantages of the invention may be learned by the practice of the invention or will be obvious from the description, as set forth hereinafter.

### BRIEF DESCRIPTION OF THE DRAWINGS

In order that the manner in which the above recited and other features and advantages of the present invention are obtained, a more particular description of the invention will be rendered by reference to specific embodiments thereof, which are illustrated in the appended drawings. Understanding that the drawings depict only typical embodiments of the present invention and are not, therefore, to be considered as limiting the scope of the invention, the present invention will be described and explained with additional specificity and detail through the use of the accompanying drawings in which:

FIG. 1 illustrates a representative system that provides a suitable operating environment for use of the present invention;

FIG. 2 illustrates a representative networked computer environment; and

FIG. 3 is a flow chart that illustrates representative processing to eliminate duplicate documents.

### DETAILED DESCRIPTION OF THE INVENTION

The present invention relates to eliminating duplicate document information and document images (collectively “documents”) prior to or after coding, rekeying, using optical character recognition, searching or producing the documents. In particular, the present invention relates to systems and methods for identifying sample areas of documents, comparing pixels of the sample areas, and performing a more detailed sampling and comparison process if the pixels of the original sample areas match. In at least some embodiments of the present invention, ISO 2859 sampling standards are employed, which are standards promulgated by the International Organization for Standardization relating to acceptance sampling procedures.

Embodiments of the present invention embrace a computer device that is used to eliminate duplicate documents prior to or after coding the documents. Multiple documents are compared to determine whether or not they are duplicate documents. This process includes identifying corresponding sample areas or points of the documents and comparing the corresponding pixels of the sample areas or points to determine whether or not the pixels are identical. If no match occurs, it is determined that the documents are not identical. However, if the pixels in the corresponding sample areas or points match, a more detailed sampling process and a more complex comparison technique is utilized to confirm whether or not the documents are in fact duplicate copies.

In some embodiments, the systems and methods of the present invention are utilized for the purpose of identifying duplicate documents before they undergo a coding process. The elimination of duplicate copies prior to coding eliminates the use of unnecessary processing power and resources since duplicate copies of the same document are no longer being coded. The elimination of duplicate documents also reduces the time necessary to conduct searches in an electronic database since the user no longer needs to go through the identified duplicate documents. In some computer environments, the elimination of duplicate copies provides the advantage of allowing a search engine to work faster than with previous techniques since the search engine no longer needs to find and identify several copies of the same document. Further, hardware needed for storage of electronic data is reduced when duplicate documents are eliminated.

In one embodiment, only one document is preserved. In another embodiment, the duplicates are preserved in a separate location, such as in an extra file in a database. In a further embodiment, information relating to the duplicate copies is tracked. For example, information relating to the users or computers that have accessed a duplicate copy is tracked.

The following disclosure of the present invention is grouped into two subheadings, namely “Exemplary Operating Environment” and “Eliminating Duplicate Documents.” The utilization of the subheadings is for convenience of the reader only and is not to be construed as limiting in any sense.

### Exemplary Operating Environment

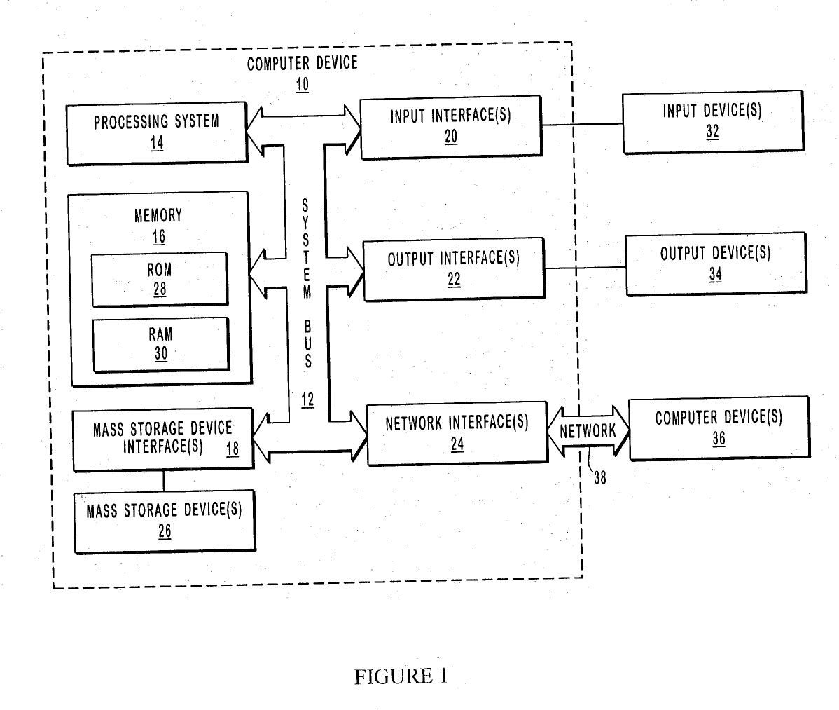

FIG. 1 and the corresponding discussion are intended to provide a general description of a suitable operating environment in which the invention may be implemented. One skilled in the art will appreciate that the invention may be practiced by one or more computing devices and in a variety of system configurations, including in a networked configuration. One example of a networked configuration is the internet.

Embodiments of the present invention embrace one or more computer readable media, wherein each medium may be configured to include or includes thereon data or computer executable instructions for manipulating data. The computer executable instructions include data structures, objects, programs, routines, or other program modules that may be accessed by a processing system, such as one associated with a general-purpose computer capable of performing various different functions or one associated with a special-purpose computer capable of performing a limited number of functions. Computer executable instructions cause the processing system to perform a particular function or group of functions and are examples of program code means for implementing steps for methods disclosed herein. Furthermore, a particular sequence of the executable instructions provides an example of corresponding acts that may be used to implement such steps. Examples of computer readable media include random-access memory (“RAM”), read-only memory (“ROM”), programmable read-only memory (“PROM”), erasable programmable read-only memory (“EPROM”), electrically erasable programmable read-only memory (“EEPROM”), compact disk read-only memory (“CD-ROM”), or any other device or component that is capable of providing data or executable instructions that may be accessed by a processing system.

With reference to FIG. 1, a representative system for implementing the invention includes computer device 10, which may be a general-purpose or special-purpose computer. For example, computer device 10 may be a personal computer, a notebook computer, a personal digital assistant (“PDA”) or other hand-held device, a workstation, a minicomputer, a mainframe, a supercomputer, a multi-processor system, a network computer, a processor-based consumer electronic device, or the like.

Computer device 10 includes system bus 12, which may be configured to connect various components thereof and enables data to be exchanged between two or more components. System bus 12 may include one of a variety of bus structures including a memory bus or memory controller, a peripheral bus, or a local bus that uses any of a variety of bus architectures. Typical components connected by system bus 12 include processing system 14 and memory 16. Other components may include one or more mass storage device interfaces 18, input interfaces 20, output interfaces 22, and/or network interfaces 24, each of which will be discussed below.

Processing system 14 includes one or more processors, such as a central processor and optionally one or more other processors designed to perform a particular function or task. It is typically processing system 14 that executes the instructions provided on computer readable media, such as on memory 16, a magnetic hard disk, a removable magnetic disk, a magnetic cassette, an optical disk, or from a communication connection, which may also be viewed as a computer readable medium.

Memory 16 includes one or more computer readable media that may be configured to include or includes thereon data or instructions for manipulating data, and may be accessed by processing system 14 through system bus 12. Memory 16 may include, for example, ROM 28, used to permanently store information, and/or RAM 30, used to temporarily store information. ROM 28 may include a basic input/output system (“BIOS”) having one or more routines that are used to establish communication, such as during start-up of computer device 10. RAM 30 may include one or more program modules, such as one or more operating systems, application programs, and/or program data.

One or more mass storage device interfaces 18 may be used to connect one or more mass storage devices 26 to system bus 12. The mass storage devices 26 may be incorporated into or may be peripheral to computer device 10 and allow computer device 10 to retain large amounts of data. Optionally, one or more of the mass storage devices 26 may be removable from computer device 10. Examples of mass storage devices include hard disk drives, magnetic disk drives, tape drives and optical disk drives. A mass storage device 26 may read from and/or write to a magnetic hard disk, a removable magnetic disk, a magnetic cassette, an optical disk, or another computer readable medium. Mass storage devices 26 and their corresponding computer readable media provide nonvolatile storage of data and/or executable instructions that may include one or more program modules such as an operating system, one or more application programs, other program modules, or program data. Such executable instructions are examples of program code means for implementing steps for methods disclosed herein.

One or more input interfaces 20 may be employed to enable a user to enter data and/or instructions to computer device 10 through one or more corresponding input devices 32. Examples of such input devices include a keyboard and alternate input devices, such as a mouse, trackball, light pen, stylus, or other pointing device, a microphone, a joystick, a game pad, a satellite dish, a scanner, a camcorder, a digital camera, and the like. Similarly, examples of input interfaces 20 that may be used to connect the input devices 32 to the system bus 12 include a serial port, a parallel port, a game port, a universal serial bus (“USB”), a firewire (IEEE 1394), or another interface.

One or more output interfaces 22 may be employed to connect one or more corresponding output devices 34 to system bus 12. Examples of output devices include a monitor or display screen, a speaker, a printer, and the like. A particular output device 34 may be integrated with or peripheral to computer device 10. Examples of output interfaces include a video adapter, an audio adapter, a parallel port, and the like.

One or more network interfaces 24 enable computer device 10 to exchange information with one or more other local or remote computer devices, illustrated as computer devices 36, via a network 38 that may include hardwired and/or wireless links. Examples of network interfaces include a network adapter for connection to a local area network (“LAN”) or a modem, wireless link, or other adapter for connection to a wide area network (“WAN”), such as the Internet. The network interface 24 may be incorporated with or peripheral to computer device 10. In a networked system, accessible program modules or portions thereof may be stored in a remote memory storage device. Furthermore, in a networked system computer device 10 may participate in a distributed computing environment, where functions or tasks are performed by a plurality of networked computer devices.

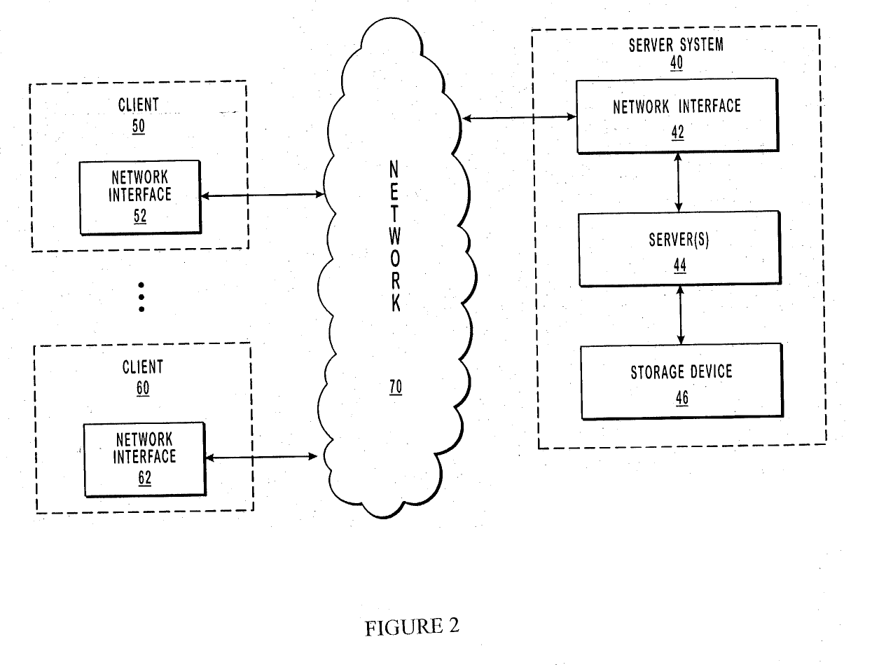

While those skilled in the art will appreciate that the invention may be practiced in networked computing environments with many types of computer system configurations, FIG. 2 represents an embodiment of the present invention in a networked environment that includes a variety of clients connected to a server via a network. While FIG. 2 illustrates an embodiment that includes multiple clients connected to the network, alternative embodiments include one client connected to a network, one server connected to a network, or a multitude of clients throughout the world connected to a network, where the network is a wide area network, such as the Internet. Moreover, embodiments of the present invention embrace non-networked environments, such as where duplicate documents are eliminated in a single computer device.

In FIG. 2, a representative networked configuration is provided for which the elimination of duplicate documents occurs. Server system 40 represents a system configuration that includes one or more servers. Server system 40 includes a network interface 42, one or more servers 44, and a storage device 46. A plurality of clients, illustrated as clients 50 and 60, communicate with server system 40 via network 70, which may include a wireless network, a local area network, and/or a wide area network. Network interfaces 52 and 62 are communication mechanisms that respectfully allow clients 50 and 60 to communicate with server system 40 via network 70. For example, network interfaces 52 and 62 may be a web browser or other network interface. A browser allows for a uniform resource locator (“URL”) or an electronic link to be used to access a web page sponsored by a server 44. Therefore, clients 50 and 60 may independently access or exchange information with server system 40.

As provided above, server system 40 includes network interface 42, servers 44, and storage device 46. Network interface 42 is a communication mechanism that allows server system 40 to communicate with one or more clients via network 70. Servers 44 include one or more servers for processing and/or preserving information. Storage device 46 includes one or more storage devices for preserving information, such as electronic documents having images. Storage device 46 may be internal or external to servers 44.

### Eliminating Duplicate Documents

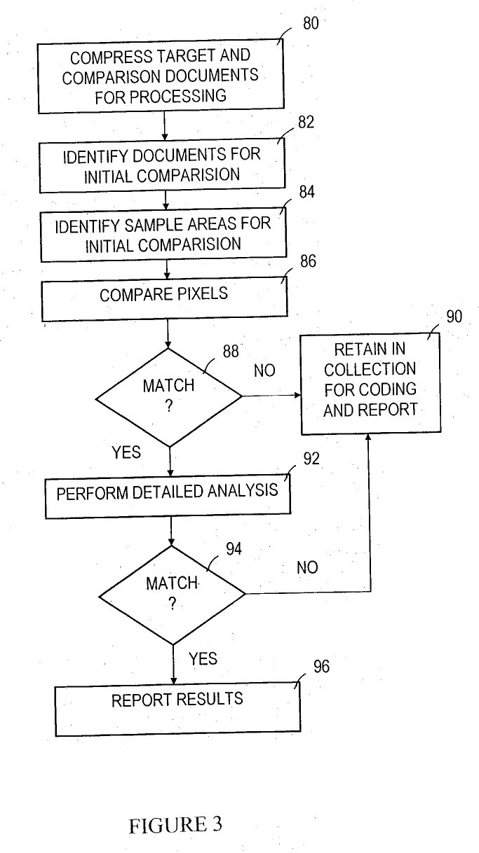

As provided above, embodiments of the present invention take place in association with the ability to eliminate duplicate document information and document images (collectively “documents”) prior to or after coding, rekeying, using optical character recognition, searching or producing the documents. Accordingly, with reference now to FIG. 3, representative processing that allows for elimination of duplicate documents prior to or after coding is provided.

In FIG. 3, execution begins in at step 80 where compression of the target and comparison documents is performed for processing. At step 82, a plurality of documents are identified for an initial comparison process to occur. At step 84, corresponding sample areas or points are identified from the plurality of documents for the initial comparison. At step 86, the pixels of the corresponding sample areas or points are compared. Execution then proceeds to decision block 88 for determination as to whether or not corresponding pixels are identical or otherwise provide a match. If it is determined that decision block 88 that the corresponding pixels are not identical, execution proceeds to step 90 where the documents are retained in a collection for coding and are reported.

Alternatively, if it is determined at decision block 88 that the pixels are identical, execution proceeds to step 92. At step 92 a detailed analysis is performed. In one embodiment, a detailed analysis includes comparing pixels from additional sample areas or points of the corresponding documents. In other embodiments, a more detailed sampling of areas and/or more complex comparison processes are utilized. Execution then proceeds to decision block 94 to determine whether or not a match occurred in the detailed analysis performed at step 92. If it is determined at decision block 94 that a match did not occur, execution proceeds to step 90, where the documents are retained in a collection for coding and are reported. Alternatively, if it is determined at decision block 94 that a match occurred in the detailed analysis performed at step 92, execution proceeds to step 96 where the results are reported. In at least some embodiments, the reporting of the results includes eliminating duplicate documents. In one embodiment, the elimination of duplicate documents includes deleting the duplicate documents from the storage device. In another embodiment, the elimination of duplicate documents includes moving the duplicate documents to another location and optionally tracking information relating to the duplicate documents. An example of such information that may be tracked includes information relating to users and/or computers that have accessed the duplicate documents.

In at least some embodiments of the present invention, images or documents are pre-processed before they are compared. The pre-processing of the images or documents reduces the size of the images and thus aids in the speed of processing. As illustrated herein, duplicate copies of documents or images are identified in order for there elimination. In further embodiments, users are able to quickly review potential duplicate images and determine whether or not the images or documents are in tact duplicate copies thereof. In one embodiment, the users are presented with a split screen orientation of multiple documents to allow the user to effectively review and determine whether the documents are duplicates.

In some embodiments of the present invention, as stand alone software application is provided that has the ability to quickly compare two sets of images for the purposes of identifying duplicate images. The systems and methods of the present invention provide accuracy and reliability in identifying and eliminating duplicate copies of documents. Accordingly, manipulation or use of the documents is significantly sped up due to the elimination of the duplicate documents.

In one embodiment, two sets of images are quickly compared for the purpose of identifying duplicate images. For example, 10,000 source images are compared against one million search images and a list of duplicate images is obtained in a relatively small amount of time such as within a hundred hours. In a further embodiment, the search images are in a search directory and the search directory is entered into a process that identifies or locates the documents or images. The source images are also in a directory. The input sets of images (source set and search set) are specified by text files that contain paths to the images. The training files and the search files are entered into the software application either by an automatic process or upon user initiation.

In some embodiments in the present invention, the ability to control the level at which the application defines a duplicate is provided. For example, the output of results in one embodiment via text file listing the duplicate images when the comparison is completed. In a further embodiment, only the images ranked at or above the ranking defined by the user will be included in this output.

In another embodiment, the output file includes a list of images that are considered to be duplicates. In one embodiment, the output file format is a text file that includes a list of blocks, such as the following:

Line 1: input source? image, for example C:\abc\t1.jpg;

Line 2: matched images, for example C:\def\s1.jpg;

Line 3: matching score, for example 123456;

Line 4: matched images, for example C:\def\s17.jpg;

Line 5: matching score, for example 123412;

. . .

Line N: a blank line

C:\abc\t1.jpg

C:\def\s17.jpg

123456

C:\def\s17.jpg

123412

C:\abc\t2.jpg

C:\def\s2.jpg

Accordingly, at least some of the embodiments of the present invention embrace the ability to compare multiple images or documents, obtain input from multiple files, and return an output file to identify the duplicate documents or images.

In one embodiment of the present invention, a single document or image is compared to three million images. In another embodiment of the present invention, multiple documents or images are compared to a variety of images. For example, one thousand images are compared to one thousand images. In another example, one thousand images are compared to three million images. Accordingly, embodiments of the present invention embrace the ability to match any number of images against any other number of images.

In a further embodiment, the output is in HTML file with links to the images and matching scores. In another embodiment, the training input files and search input files are specified in a corresponding output text file is produced that needs specified requirements for an output file.

The following provides a representative example of comparing documents:

A comparison of 10,000 images with 1,000,000 images requires 10,000,000,000 comparisons. The expected run time is 100 hours=6,000 minutes=360,000 seconds. The speed for a typical jpeg image is about 10 images per second. Accordingly, the number of comparisons that can be produced in 100 hours is 3,600,000. The ratio of existing capability versus the required capability is:

$$\frac{\text{3,600,000}}{\text{10,000,000,000}} = \frac{3.6}{\text{10,000}} = 0.036 \%$$

In the present example, in order to meet the required time requirements multiple computer devices are used to get a linear increase of speed. By splitting the work load to multiple computers, the speed is increased linearly. Accordingly, if 10 computers are used then the ratio is 0.36%

To further meet the required time requirements, sliding windows may be used. For example, an optimization procedure is utilized. Accordingly, rather than comparing each source image with each search image, a source image is only compared with a part of a search image, those parts being in a sliding window. To implement this embodiment, some attributes of images are calculated in advance and results are stored in a database. For example, if the attribute is “X” with a possible value of 0-1,000, when a new image is presented the attribute will first be calculated (X=X′) and a query will be made on the database to obtain selective images (e.g., X=X′−1, X, X′+1). As a result, only those images in the sliding window (X=X′−1, X, X′+1) are compared.

Thus, as discussed herein, the embodiments of the present invention embrace eliminating duplicate document information and document images (collectively “documents”) prior to or after coding, rekeying, using optical character recognition, searching or producing the documents. In particular, the present invention relates to systems and methods for identifying sample areas of documents, comparing pixels of the sample areas, and performing a more detailed sampling and comparison process if the pixels of the original sample areas match.

The present invention may be embodied in other specific forms without departing from its spirit or essential characteristics. The described embodiments are to be considered in all respects only as illustrative and not restrictive. The scope of the invention is, therefore, indicated by the appended claims rather than by the foregoing description. All changes that come within the meaning and range of equivalency of the claims are to be embraced within their scope.

What is claimed is:

1. A method for eliminating duplicate digitized documents from a group of documents to reduce the time in searching that group of documents, the method comprising the steps of:
providing a first digitized document and a second digitized document, wherein the first and second digitized documents are included in the group of documents;
determining whether the first digitized document is a duplicate of the second digitized document, wherein the step for determining includes the steps of:
identifying a sample area of the first digitized document and a corresponding sample area of the second digitized document; and
comparing pixels of the sample area of the first digitized document with corresponding pixels of the sample area of the second digitized document; and
if the first digitized document is a duplicate of the second digitized document, selectively marking one of the documents as a duplicate to reduce an amount of time required to accurately and completely search the group of documents.

2. A method as recited in claim 1, wherein the step of determining whether the first digitized document is a duplicate of the second digitized document is performed prior to performing at least one of:
(i) a coding process;
(ii) a rekeying process;
(iii) an optical character recognition process; and
(iv) a searching process.

3. A method as recited in claim 1, wherein the step of determining whether the first digitized document is a duplicate of the second digitized document is performed after performing at least one of:
(i) a coding process;
(ii) a rekeying process;
(iii) an optical character recognition process; and
(iv) a searching process.

4. A method as recited in claim 1, wherein the step of comparing pixels of the sample area of the first digitized document with corresponding pixels of the sample area of the second digitized document comprises:
if the pixels of the sample area of the first digitized document are substantially similar to the corresponding pixels of the sample area of the second digitized document, performing a step of analyzing additional areas of the first digitized document with corresponding additional areas of the second digitized document to determine whether the corresponding additional areas of the first and second digitized documents are substantially similar.

5. A method as recited in claim 1, further comprising a step of eliminating one of the documents.

6. A method as recited in claim 1, further comprising a step of preserving the duplicate document in a separate location.

7. A method as recited in claim 6, wherein the separate location is a file in a database.

8. A method as recited in claim 1, further comprising a step of tracking information relating to the duplicate document.

9. A method as recited in claim 8, wherein the information relating to the duplicate document includes data relating to a accessing history of the duplicate document.

10. A method as recited in claim 1, wherein if the first digitized document is not a duplicate of the second digitized document, performing a step of retaining both the first and second digitized documents in a collection.

11. A method as recited in claim 1, further comprising a step of providing a comparison report of the first and second digitized documents.

12. A method for improving the quality of digitized document discovery by identifying duplicate digitized documents from a group of documents, the method comprising the steps of:
providing a first digitized document and a second digitized document, wherein the first and second digitized documents are included in the group of documents;
determining whether the first digitized document is a duplicate of the second digitized document, wherein the step for determining includes the steps of:
identifying a sample area of the first digitized document and a corresponding sample area of the second digitized document; and
comparing pixels of the sample area of the first digitized document with corresponding pixels of the sample area of the second digitized document;
if the first digitized document is a duplicate of the second digitized document, identifying that one of the documents as a duplicate document to enhance a digitized document discovery process; and
providing a bundle of documents for a document discovery process, wherein the bundle does not include the duplicate document.

13. A method as recited in claim 12, further comprising a step of eliminating the duplicate document.

14. A method as recited in claim 12, further comprising a step of preserving the duplicate document in a separate location.

15. A method as recited in claim 12, further comprising a step of tracking information relating to the duplicate document.

16. A method as recited in claim 12, wherein the step for providing the first digitized document and the second digitized document includes the steps of:
obtaining the first digitized document from a first source; and
obtaining the second digitized document from a second source.

17. A computer program product for implementing within a computer system a method for eliminating duplicate digitized documents from a group of documents to reduce the time in searching that group of documents, the computer program product comprising:
a computer readable medium for providing computer program code means utilized to implement the method, wherein the computer program code means is comprised of executable code for implementing the steps of:
determining whether a first digitized document of a group of documents is a duplicate of a second digitized document, wherein the step for determining includes the steps of:
identifying a sample area of the first digitized document and a corresponding sample area of the second digitized document; and
comparing pixels of the sample area of the first digitized document with corresponding pixels of the sample area of the second digitized document; and
if the first digitized document is a duplicate of the second digitized document, selectively marking one of the documents as a duplicate to reduce an amount of time required to search the group of documents.

18. A computer program product as recited in claim 17, wherein the step of determining whether the first digitized document is a duplicate of the second digitized document is performed prior to performing at least one of:
(i) a coding process;
(ii) a rekeying process;
(iii) an optical character recognition process; and
(iv) a searching process.

19. A computer program product as recited in claim 17, wherein the step of determining whether the first digitized document is a duplicate of the second digitized document is performed after performing at least one of:
(i) a coding process;
(ii) a rekeying process;
(iii) an optical character recognition process; and
(iv) a searching process.

20. A computer program product as recited in claim 17, wherein the computer program code means is further comprised of executable code for implementing steps comprising:
obtaining the first digitized document from a first location; and
obtaining the second digitized document from a second location.
